(19) United States
(12) Patent Application Publication
(10) Pub. No.: US 2023/0282806 A1
(43) Pub. Date: Sep. 7, 2023

(54) ZINC METAL ANODE INCLUDING A PROTECTIVE LAYER AND ZINC METAL BATTERY USING THE SAME

(71) Applicant: INDUSTRY ACADEMY COOPERATION FOUNDATION OF SEJONG UNIVERSITY, Seoul (KR)

(72) Inventors: Seung Taek MYUNG, Seoul (KR); Hee Jae Kim, Seoul (KR); Sun Kim, Seoul (KR)

(73) Assignee: INDUSTRY ACADEMY COOPERATION FOUNDATION OF SEJONG UNIVERSITY, Seoul (KR)

(21) Appl. No.: 18/176,801

(22) Filed: Mar. 1, 2023

(30) Foreign Application Priority Data
Mar. 2, 2022 (KR) 10-2022-0026488
May 31, 2022 (KR) 10-2022-0066926

(51) Int. Cl. H01M 4/24; H01M 10/36; H01M 4/26

(52) U.S. Cl. CPC H01M 4/244; H01M 10/365; H01M 4/26

(57) ABSTRACT

An anode for a zinc metal battery and a zinc metal battery using the same are provided. An anode for a zinc metal battery includes a zinc metal film and a protective layer formed on a surface of the zinc metal film, and the protective layer may be zinc phosphate. Since the protective layer coats the outermost surface of the zinc metal film, direct contact of the zinc metal film with an electrolyte can be prevented. Accordingly, zinc dendrites formed during plating/stripping of zinc ions during charging and discharging of the battery may grow uniformly, and thus, short circuit of the battery may be prevented.

### CROSS-REFERENCE TO RELATED APPLICATION

This application claims priority to and the benefit of Korean Patent Applications No. 2022-0066926, filed on May 31, 2022 and No. 2022-0026488, filed on Mar. 2, 2022, the disclosure of which is incorporated herein by reference in its entirety.

### BACKGROUND

### 1. Field of the Invention

The present invention relates to a secondary battery, and more particularly to a zinc metal battery.

### 2. Discussion of Related Art

In recent years, as portable wireless devices such as portable phones and portable computers have been made lighter and more functional, a lot of research has been conducted on secondary batteries used as driving power sources of them. Examples of the secondary batteries include a nickel cadmium battery, a nickel hydride battery, a nickel zinc battery, and a lithium secondary battery. Among them, lithium secondary batteries are widely used in the field of advanced electronic devices because they are rechargeable, have high operating voltage, and have high energy density per unit weight.

Meanwhile, as various technologies for wearable electronic devices beyond the flexible electronic devices have recently been developed, the demand for secondary batteries that operate with materials with high stability and no risk of explosion is also increasing. In relation to this, zinc secondary batteries have the advantages of being more stable than other secondary batteries, eco-friendly, less toxic, and more economical than other alkali metal secondary batteries. Currently, research on zinc secondary batteries using zinc metal as an electrode material is being actively conducted.

An electrolyte of a general zinc secondary battery uses an aqueous solvent having high ionic conductivity and low fire risk. However, there is a limitation in the voltage range in which charging and discharging of the battery is performed, and there is a problem in that the probability of occurrence of zinc dendrites is high due to high ionic conductivity compared to organic solvents.

### SUMMARY OF THE INVENTION

The present invention is directed to provide an anode including a protective layer and a zinc metal battery including the same for suppressing the growth of zinc dendrites on the anode when an aqueous electrolyte is used.

The technical tasks of the present invention are not limited to the technical tasks mentioned above, and other technical tasks not mentioned will be clearly understood by those skilled in the art from the following description.

In order to solve the above tasks, one aspect of the present invention is to provide an anode for zinc metal battery comprising a zinc metal film containing zinc metal, and a protective layer formed on the surface of the zinc metal film.

In ToF-SIMS analysis, PO⁻, HPO⁻, ZnPO⁻ and ZnHPO⁻ peaks can be detected from the protective layer.

The protective layer may include zinc phosphate.

The protective layer may have an orthorhombic structure as a crystal structure, and a space group thereof may be Pnma.

The protective layer may have a thickness of 5 to 15 nm.

In order to solve the above tasks, another aspect of the present invention provides a method for manufacturing an anode for a zinc metal battery comprising immersing zinc metal in an aqueous phosphate solution, and subjecting it to ultrasonic treatment to form a protective layer.

The ultrasonic treatment time may be 1 to 30 minutes, and may be 5 to 15 minutes in detail.

In order to solve the above tasks, another aspect of the present invention is to provide a zinc metal battery comprising an anode including a zinc metal film containing zinc metal and a protective layer formed on the surface of the zinc metal film, a cathode containing a cathode active material, and an aqueous electrolyte disposed between the anode and the cathode and containing a zinc salt.

The cathode active material may include alkali metal vanadium oxide or vanadium oxide.

The alkali metal vanadium oxide may be MₓV₃O₈, M may be an alkali metal, and x may be 0.8 to 2.2.

The alkali metal vanadium oxide may include at least one selected from LiV₃O₈, NaV₃O₈ and K₂V₃O₈.

The vanadium oxide may include at least one selected from VO₂(B), V₂O₃ and V₂O₅.

The zinc salt may include at least one selected from ZnSO₄, Zn(NO₃)₂, Zn(CH₃CO₂)₂, Zn(CF₃SO₃)₂, ZnCl₂, and Zn(ClO₄)₂.

The aqueous electrolyte may have a pH of 3 to 7.

According to the present invention described above, an anode for a zinc metal battery according to the present invention includes a zinc metal film and a protective layer such as zinc phosphate formed on a surface of the zinc metal film, and the protective layer coats the outermost surface of the zinc metal film to prevent direct contact of zinc metal with an aqueous electrolyte. Therefore, there is an effect of helping uniform growth of zinc dendrites formed during plating/stripping of zinc ions during the charging and discharging process of the battery and preventing a short circuit of the battery.

### BRIEF DESCRIPTION OF THE DRAWINGS

The patent or application file contains at least one drawing executed in color. Copies of this patent or patent application publication with color drawings will be provided by the Office upon request and payment of the necessary fee. The above and other objects, features, and advantages of the present invention will become more apparent to those of ordinary skill in the art by describing in detail exemplary embodiments thereof with reference to the adhered drawings, in which:

FIG. 1 is a schematic diagram showing a structure of a zinc metal battery according to an embodiment of the present invention.

FIG. 2 shows SEM images of the surface of the anode for the zinc metal battery having the protective layer formed thereon according to Preparation Example 1 and the surface of the anode of Comparative Example 1, and the insets are digital camera images of the surface of the anode for the zinc metal battery having the protective layer formed thereon according to Preparation Example 1 and the surface of the anode of Comparative Example 1.

FIG. 3 is an XPS depth profile of an anode for a zinc metal battery having a protective layer formed thereon according to Preparation Example.

FIG. 4 shows ToF-SIMS results of an anode for a zinc metal battery on which a protective layer is formed according to Preparation Example, and shows PO⁻ and HPO⁻ peaks.

FIG. 5 shows ToF-SIMS results of an anode for a zinc metal battery on which a protective layer is formed according to Preparation Example, and shows ZnPO⁻ and ZnHPO⁻ peaks.

FIG. 6 is an XRD result of an anode for a zinc metal battery on which a protective layer is formed according to Preparation Example.

FIG. 7 is a cycle test result of a symmetric cell to which an anode having a protective layer formed thereon is applied according to Manufacturing Example, and a charge/discharge cycle is performed to have a capacity of 1 mAh/cm² per cycle at a current density of 1 mA/cm².

FIG. 8 is a cycle test result of a symmetric cell to which an anode having a protective layer formed thereon is applied according to Manufacturing Example, and a charge/discharge cycle is performed to have a capacity of 1 mAh/cm² per cycle at a current density of 5 mA/cm².

FIG. 9 is a synchrotron in situ imaging test result of a symmetric cell to which an anode having a protective layer formed thereon is applied according to a Manufacturing Example.

FIG. 10 shows SEM images of a surface of an anode after synchrotron in situ imaging test of a symmetric cell to which an anode having a protective layer formed thereon is applied according to Manufacturing Example.

FIG. 11 is a synchrotron in situ 3D image of a zinc metal anode according to Comparation Example.

FIG. 12 is a synchrotron in situ 3D image of an anode for a zinc metal battery on which a protective layer is formed according to Manufacturing Example.

FIG. 13a is a SEM image of a surface of an anode of a symmetrical cell according to Comparative Example after a cycle test under the conditions of a current density of 5 mA/cm² and a capacity of 1 mAh/cm² per cycle.

FIG. 13b is a digital camera image of a separator of a symmetrical cell according to Comparative Example after a cycle test under the conditions of a current density of 5 mA/cm² and a capacity of 1 mAh/cm² per cycle.

FIG. 14a is a SEM image of a surface of an anode including a protective layer of a symmetrical cell according to Manufacturing Example after a cycle test (condition: 5 mA/cm²//1 mAh/cm²).

FIG. 14b is a digital camera image of a separator of a symmetrical cell to which an anode having a protective layer formed thereon is applied according to Manufacturing Example after a cycle test (condition: 5 mA/cm²//1 mAh/cm²).

FIG. 15a is a first charge/discharge graph of a zinc metal battery to which a zinc metal anode is applied according to Comparative Example.

FIG. 15b is a first charge/discharge graph of a zinc metal battery to which an anode having a protective layer is applied according to Manufacturing Example.

FIG. 16 is a result of 1000 charge/discharge cycle test of a zinc metal battery to which an anode having a protective layer is applied according to Manufacturing Example and a zinc metal battery to which a zinc metal anode is applied according to Comparative Example.

FIG. 17a shows digital camera images of a separator (left) and an anode (right) after 1000 charge/discharge cycle test of a zinc metal battery to which a zinc metal anode is applied according to Comparative Example.

FIG. 17b shows a digital camera image of a separator (left) and an anode (right) after 1000 charge/discharge cycle test of a zinc metal battery to which an anode having a protective layer is applied according to Manufacturing Example.

### DETAILED DESCRIPTION OF EXEMPLARY EMBODIMENTS

Since the present invention may have various changes and various forms, specific embodiments are illustrated in the drawings and described in detail in the description. However, it should be understood that this is not intended to limit the present invention to the specific disclosed form, and includes all modifications, equivalents, and substitutes included in the spirit and scope of the present invention. Like reference numerals have been used for like elements throughout the description of each figure.

Unless defined otherwise, all terms used herein, including technical or scientific terms, have the same meaning as commonly understood by one of ordinary skill in the art to which the present invention belongs. Terms such as those defined in commonly used dictionaries should be interpreted as having a meaning consistent with the meaning in the context of the related art, and unless explicitly defined in the present application, they should not be interpreted in an ideal or excessively formal meaning.

Hereinafter, with reference to the accompanying drawings, preferred embodiments of the present invention will be described in more detail.

Zinc Metal Battery

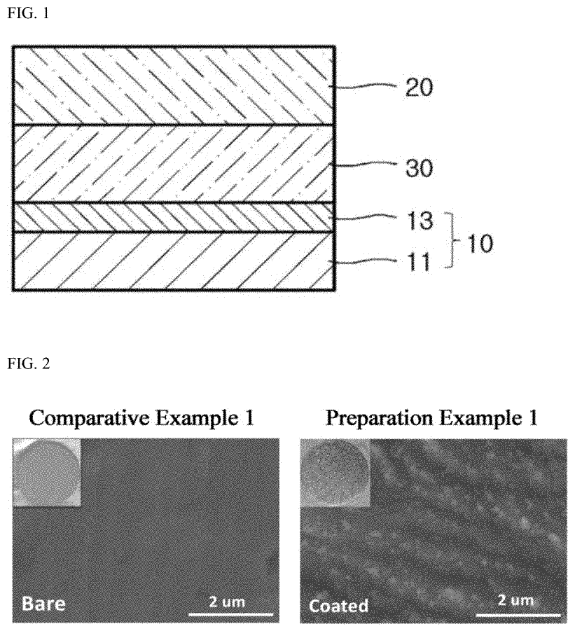

FIG. 1 is a schematic diagram showing a structure of a zinc metal battery according to an embodiment of the present invention.

The zinc metal battery according to an embodiment of the present invention includes an anode 10 including zinc metal film 11 and a protective layer 13 formed on a surface of the zinc metal film 11; a cathode 20 including a cathode active material; and an aqueous electrolyte 30 disposed between the anode 10 and the cathode 20 and containing a zinc salt.

Anode

Referring to FIG. 1, an anode 10 for a zinc metal battery according to an embodiment of the present invention may include zinc metal film 11 and a protective layer 13 formed on a surface of the zinc metal film 11.

The standard electrode potential of zinc (Zn²⁺+2e⁻→Zn) is −0.76 V (vs. SHE), and the theoretical mass specific capacity of zinc is 412 mAh/g. Zinc metal is one of the possible candidate materials as an anode material for batteries that require high capacity in a limited volume. In addition, since the zinc metal is considerably cheaper than lithium metal, it is possible to solve the problem of unstable supply of lithium metal, and since it has a lower reactivity than lithium metal, a relatively stable battery can be provided.

The zinc metal film 11 is a layer containing zinc metal, and may be a pure zinc metal film or a zinc alloy layer. The zinc alloy can be alloy of zinc and other metals.

The anode 10 may have the pure zinc metal film or the zinc alloy layer in the form of a foil or flake, and having a thickness of 100 μm to 1000 μm, for example, 200 μm to 500 μm, but is not limited thereto.

The anode 10 may include a protective layer 13 formed on the surface of the zinc metal film 11.

The protective layer 13 may include zinc phosphate. Specifically, the protective layer 13 may be zinc phosphate of hopeite, have an orthorhombic structure as a crystal structure, and may have a space group of Pnma.

In ToF-SIMS analysis, PO⁻, HPO⁻, ZnPO⁻, and ZnHPO⁻ peaks may be detected from the protective layer 13.

In addition, the protective layer 13 may be formed through the reaction of Chemical Formula 1 below:

3Zn+2H₃PO₄+4H₂O→Zn₃(PO₄)₂·4H₂O+3H₂ [Chemical Formula 1]

The protective layer 13 may include zinc phosphate (Zn₃(PO₄)₂·4H₂O) formed by reacting zinc metal with phosphoric acid. Specifically, the protective layer 13 may be formed by immersing the zinc metal film in a phosphoric acid aqueous solution and performing ultrasonic treatment at room temperature for 1 to 30 minutes, for example, 10 minutes. In addition, the protective layer 13 may be formed on one surface of the zinc metal film, specifically, at least one surface immersed and contacted with the phosphoric acid aqueous solution. Thus, the anode 10 may include the zinc metal film 11 containing zinc metal, and the protective layer 13 formed on at least one surface of the zinc metal film 11 in contact with the outside, specifically the protective layer 13 may includes zinc phosphate.

When the anode 10 including the protective layer 13 is assembled into a battery, direct contact of zinc metal with the electrolyte can be prevented. In the case of a zinc secondary battery using zinc metal as an electrode, a side reaction by an electrochemical reaction, for example, an electrolysis reaction of water contained in the aqueous solvent can be generated due to a potential difference while driving of the secondary battery. Due to the electrolysis reaction of the water-based solvent, hydrogen gas, zinc hydroxide, or zinc oxide may be generated, and these side reactions may cause a problem in durability of the battery. However, since the zinc metal battery including the anode including the zinc phosphate layer of the present invention prevents direct contact between the electrode and the electrolyte to limit the aforementioned side reactions, the stability of the battery can be improved.

In addition, since the anode including the protective layer 13 may serve to help the uniform growth of zinc dendrites formed during the charging and discharging process of the battery, there is an effect of preventing a short circuit during plating/stripping of zinc ions within the charging and discharging process and improving cycle characteristics.

The concentration of the aqueous phosphoric acid solution may be 50 to 100 wt %, specifically 70 to 90 wt %. In one embodiment, the concentration of the aqueous phosphoric acid solution may be 85 wt %, but is not limited thereto.

The protective layer 13 may have a thickness of 5 to 15 nm. When the thickness of the protective layer is less than 5 nm, sharp and irregular zinc dendrites may be formed as zinc ions are plated on/stripped from the zinc metal used as the anode during the cycle process, thereby not only occurring a short circuit of the battery but also accelerating the deterioration of the battery by formation of dead zinc. On the other hand, when the thickness of the protective layer is greater than 15 nm, the ability to conduct zinc ions to the zinc metal film is reduced, which may hinder the charging and discharging rate of the battery. When the protective layer has a thickness within the above range, it is possible to suppress the generation of dead zinc and zinc dendrites during the cycle process in which zinc ions are plated/stripped, and also the shape of the formed zinc dendrites can be regular and evenly distributed over the entire surface of the electrode, the surface of the zinc metal can be protected and the lifespan of the battery can be improved. Specifically, the thickness of the protective layer may be 7 to 12 nm, more specifically 8 to 11 nm, and more specifically 9 to 10 nm. In one embodiment, the thickness of the protective layer may be 9.5 nm, but is not limited thereto.

Cathode

A cathode for a zinc metal battery according to the present invention may be one in which a slurry containing a cathode active material, a binder, and a conductive material is formed on a current collector.

The cathode active material may include an alkali metal vanadium oxide or a vanadium oxide.

The alkali metal vanadium oxide may be MₓV₃O₈, M may be an alkali metal, and x may be 0.8 to 2.2.

The alkali metal vanadium oxide may include at least one selected from LiV₃O₈, NaV₃O₈ and K₂V₃O₈. In one embodiment, the alkali metal vanadium oxide may be NaV₃O₈, but is not limited thereto.

The vanadium oxide may include at least one selected from VO₂(B), V₂O₃ and V₂O₅. In particular, since zinc ion (Zn²⁺), which is a divalent ion, is used as a charge carrier, it is preferable to use a vanadium-based cathode active material having a wide range of oxidation numbers from 2 to 5. In addition, since its crystal lattice size is large, insertion and desorption of zinc ions (Zn²⁺) may be facilitated during charging and discharging of the battery.

The conductive material may be used without limitation as long as it is generally usable in the art, for example artificial graphite, natural graphite, carbon black, acetylene black, ketjen black, denka black, thermal black, channel black, carbon nanofibers, carbon nanotubes, metal fibers, or mixtures thereof can be used. In one embodiment, the conductive material may be a mixture of ketjen black and super Pin a mass ratio of 1:1, but is not limited thereto.

The binder may be used without limitation as long as it is generally usable in the art, for example, polyvinylidene fluoride (PVdF), polyhexafluoropropylene-polyvinylidene fluoride copolymer (PVdF/HFP), poly(vinyl acetate), polyvinyl alcohol, polyethylene oxide, polyvinylpyrrolidone, polyvinylpyridine, alkylated polyethylene oxide, polyvinyl ether, poly(methyl methacrylate), poly(ethyl acrylate), polytetrafluoroethylene (PTFE), polyvinyl chloride, polyacrylonitrile, styrene-butadiene rubber, acrylonitrile-butadiene rubber, fluoro rubber, ethylene-propylene-diene monomer (EPDM), sulfonated ethylene-propylene-diene monomer, carboxymethylcellulose (CMC), sodium carboxymethylcellulose, regenerated cellulose, starch, hydroxypropyl cellulose, tetrafluoroethylene, or a mixture thereof may be used. In one embodiment, the binder may include sodium carboxymethyl cellulose, but is not limited thereto.

The solvent for forming the slurry containing the active material of the cathode, the binder, and the conductive material may include an aqueous solvent such as water, ethanol, isopropyl alcohol (IPA), or organic solvent such as N-methyl pyrrolidone (NMP), dimethyl formamide (DMF), acetone, and these solvents may be used alone or in combination of two or more. In one embodiment, the solvent may be water, but is not limited thereto. The amount of the solvent used may be adjusted so as to dissolve and disperse the active material, the binder, and the conductive material, and to have an appropriate viscosity of the slurry in consideration of the coating thickness and manufacturing yield.

The active material of the cathode, the binder, and the conductive material may be mixed in a certain ratio to form the slurry having appropriate viscosity and processability. The ratio of the active material, the binder, and the conductive material may be 8:1:1 in terms of mass ratio, but is not limited thereto.

The cathode may be formed on a current collector layer to a thickness of 50 to 200 μm, specifically, to a thickness of 80 to 120 μm. In one embodiment, the cathode may be formed on the current collector layer to a thickness of 100 μm, but is not limited thereto.

Separator

A separator may be disposed between the anode and the cathode to electrically insulate the electrodes. In addition, the separator is sufficiently impregnated with the aqueous electrolyte, and the porous interior thereof may allow zinc ions to move from the anode to the cathode and from the cathode to the anode.

The separator may be a conventional porous polymer film used as a separator, for example, polyolefin based porous polymer film including ethylene homopolymer, propylene homopolymer, ethylene/butene copolymer, ethylene/methacrylate copolymer, or polyvinyl alcohol, which may be used alone or in a laminated form. Alternatively, the separator may be a conventional porous nonwoven fabric formed from, for example, glass fiber, carboxymethyl cellulose, polyethylene terephthalate fiber, etc. In one embodiment, the separator may be a glass fiber membrane having a thickness of 10 to 500 μm, but is not limited thereto.

Aqueous Electrolyte

The zinc metal battery of the present invention may refer to a battery utilizing zinc ions as a charge transfer material. In other words, the zinc metal battery may include an aqueous electrolyte containing an aqueous solvent and a zinc salt to enable intercalation and deintercalation of zinc ions.

The aqueous solvent may be water.

The zinc salt may be a water-soluble salt that can generate zinc ions when dissolved in water. For example, the zinc salt may include at least one or more selected from ZnSO₄, Zn(NO₃)₂, Zn(CH₃CO₂)₂, Zn(CF₃SO₃)₂, ZnCl₂ and Zn(ClO₄)₂. In one embodiment, the zinc salt may be ZnSO₄, but is not limited thereto.

The molar concentration of the aqueous electrolyte may be 0.1 to 2 M, and in one embodiment, it may be 1 M.

The pH of the aqueous electrolyte may be 3 to 7, specifically, 4 to 5, and in one embodiment, the pH of the electrolyte may be 4.03. If the pH of the aqueous electrolyte is less than 3, there may be a problem of causing corrosion of the electrode due to the strong acidic component. On the other hand, when the pH of the aqueous electrolyte exceeds 7, there may be a problem in that the ionic conductivity decreases due to the small amount of the ion transport material in the electrolyte.

By using an aqueous electrolyte, a battery including it can have high ionic conductivity. In addition, it is advantageous in terms of stability, and the process and manufacturing cost may also be inexpensive.

Hereinafter, in order to explain the present invention in more detail, preferred experimental examples according to the present invention will be described in more detail with reference to the accompanying drawings. However, the present invention is not limited to the embodiments described herein and may be embodied in other forms.

### Preparation Example 1: Preparation of an Anode Having a Protective Layer Formed on a Zinc Metal Film

First, a zinc metal film was surface treated to prepare an anode having a zinc phosphate layer as a protective layer on a surface of the zinc metal film. The zinc metal film having holes with a diameter of 16 mm was immersed in 10 ml of an 85 wt % phosphoric acid (H₃PO₄) aqueous solution, and ultrasonic treatment was performed for 10 minutes. During the sonication process, a large amount of hydrogen gas bubbles was generated while the surface of the zinc metal reacted with phosphoric acid. The reaction-completed zinc metal film was taken out, and phosphoric acid remaining on the surface was removed using distilled water and ethanol immediately, and then dried in an oven at 60° C. for 1 hour. As a result, an anode having zinc phosphate coated on the surface of the zinc metal film was formed.

### Manufacturing Example 1: Manufacturing a Symmetrical Cell Including the Anode Having the Protective Layer Formed on the Zinc Metal Film

A symmetrical cell including the anodes prepared in Preparation Example as the working electrode and the counter electrode, a separator and an electrolyte between the working electrode and the counter electrode was prepared. A 1 M aqueous solution of ZnSO₄ was used as the electrolyte, and glass fiber membrane is used as the separator. The symmetric cell was assembled into an R2032 coin type battery by sequentially stacking the working electrode, the glass fiber separator, and the counter electrode. Then, the electrolyte was injected into the coin cell. All manufacturing processes were carried out inside the glove box.

### Manufacturing Example 2: Manufacturing a Zinc Metal Battery Including the Anode Having the Protective Layer Formed on the Zinc Metal Film

A zinc metal battery was manufactured in the same manner as in Manufacturing Example 1, except that the anode prepared in Preparation Example was used as the counter electrode and a cathode containing NaV₃O₈ as a cathode active material was used instead of the working electrode.

### Comparative Example 1: Preparation of Symmetrical Cell Using Untreated Zinc Metal as an Anode

A symmetrical cell was manufactured in the same manner as in Manufacturing Example 1, except that untreated zinc metal was used as the working electrode and the counter electrode.

### Comparative Example 2: Preparation of Zinc Metal Battery Using Untreated Zinc Metal as an Anode

A zinc metal battery was manufactured in the same manner as in Manufacturing Example 2, except that untreated zinc metal was used as an anode.

FIG. 2 shows SEM images of the surface of the anode for the zinc metal battery having the protective layer formed thereon according to Preparation Example 1 and the surface of the anode of Comparative Example 1, and the insets are digital camera images of the surface of the anode for the zinc metal battery having the protective layer formed thereon according to Preparation Example 1 and the surface of the anode of Comparative Example 1.

Referring to FIG. 2, it is confirmed that the anode surface of Preparation Example 1 on which the protective layer is formed has a relatively rough surface compared to the anode surface of Comparative Example 1, as can be seen in the low-magnification SEM images. In addition, the surface of the anode of Preparation Example 1 was observed to be shiny due to light reflection, and surface curvature aligned in a certain direction was observed.

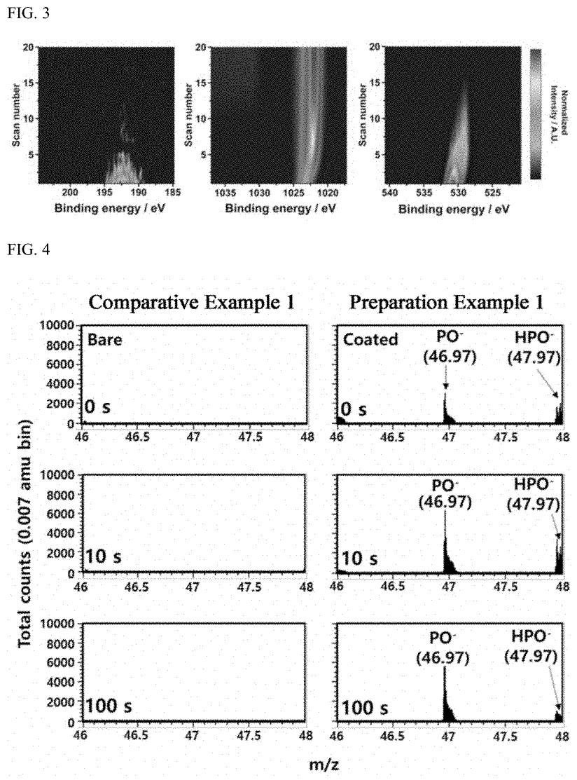

FIG. 3 is an XPS depth profile of an anode for a zinc metal battery having a protective layer formed thereon according to Preparation Example.

Referring to FIG. 3, the thickness of the protective layer can be observed. XPS depth profile was measured under the condition of an etch rate of 1.9 nm/min using Ar ion sputter on the surface of the anode of Preparation Example 1 having the protective layer. In the case of the P 2p, it was confirmed that a peak of scan number 5 appeared around the binding energy of 192.2 eV. In addition, it can be seen that the 1023 eV peak in the Zn 2p region and the 530.6 eV peak in the 0 is region also show similar behavior to that of the peak in the P 2p region through a concentration change around scan number 5. Through this, the thickness of the protective layer can be calculated. The thickness of the protective layer can be calculated as the product of the etch rate and the scan number to have 9.5 nm (=1.9×5).

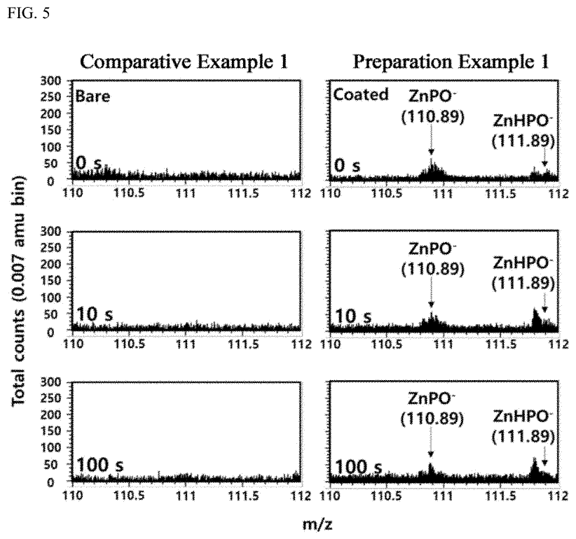

FIGS. 4 and 5 show ToF-SIMS results of an anode for a zinc metal battery on which a protective layer is formed according to Preparation Example.

ToF-SIMS (Time-of-flight secondary ion mass spectrometry) analysis is an analysis method to obtain chemical components and surface structures by analyzing the time-of-flight of cations or anions emitted from the surface of a sample by colliding primary ions with the surface.

Referring to FIGS. 4 and 5, it can be confirmed that peaks of PO⁻, HPO⁻, ZnPO⁻ and ZnHPO⁻ fragments are detected on the surface of the anode having a zinc phosphate layer as a protective layer according to Preparation Example. As a result, it can be confirmed that zinc phosphate is present in the protective layer.

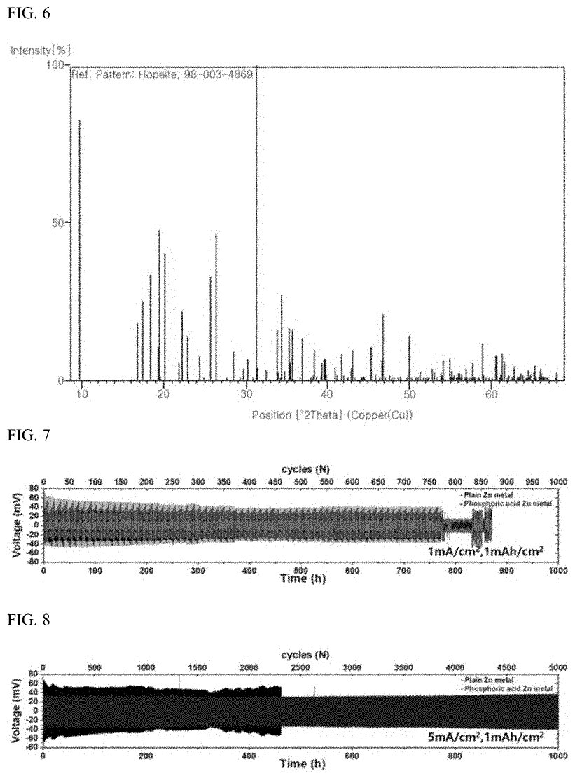

FIG. 6 is an XRD result of an anode for a zinc metal battery on which a protective layer is formed according to Preparation Example.

Referring to FIG. 6, it can be confirmed that zinc phosphate included in the protective layer of the Preparation Example is hopeite, and its crystal structure is orthorhombic and has a space group of Pnma.

FIG. 7 is a cycle test result of a symmetric cell to which an anode having a protective layer formed thereon is applied according to Manufacturing Example, and a charge/discharge cycle is performed to have a capacity of 1 mAh/cm² per cycle at a current density of 1 mA/cm².

FIG. 8 is a cycle test result of a symmetric cell to which an anode having a protective layer formed thereon is applied according to Manufacturing Example, and a charge/discharge cycle is performed to have a capacity of 1 mAh/cm² per cycle at a current density of 5 mA/cm².

Referring to FIGS. 7 and 8, when charge and discharge cycles under the conditions of capacity of 1 mAh/cm² per cycle at a current density of 1 mA/cm² were performed, in the case of Comparative Example 1, the plating/stripping overvoltage was appeared to be as high as about +60 mV/−45 mV, and a short circuit occurred at about the 775th cycle. On the other hand, in the case of Manufacturing Example 1, the plating/stripping overvoltage appeared constant at a very low level of about +10 mV/−15 mV, and a short circuit did not occur and the low overvoltage was maintained until about the 870th cycle. Meanwhile, in FIG. 8, when high-speed charge/discharge cycles under the conditions of capacity of 1 mAh/cm² per cycle at a current density of 5 mA/cm² were performed, in the case of Comparative Example 1, a short circuit occurred at about the 2300^{th} cycle. On the other hand, in the case of Manufacturing Example 1, a short circuit did not occur until about the 5000^{th} cycle. Therefore, as a result of the charge/discharge cycle test conducted under the current density of the two conditions, the symmetric cell (Manufacturing Example 1) to which the anode with a protective layer was applied had a low plating/stripping overvoltage, and short-circuit did not occur during a long cycle.

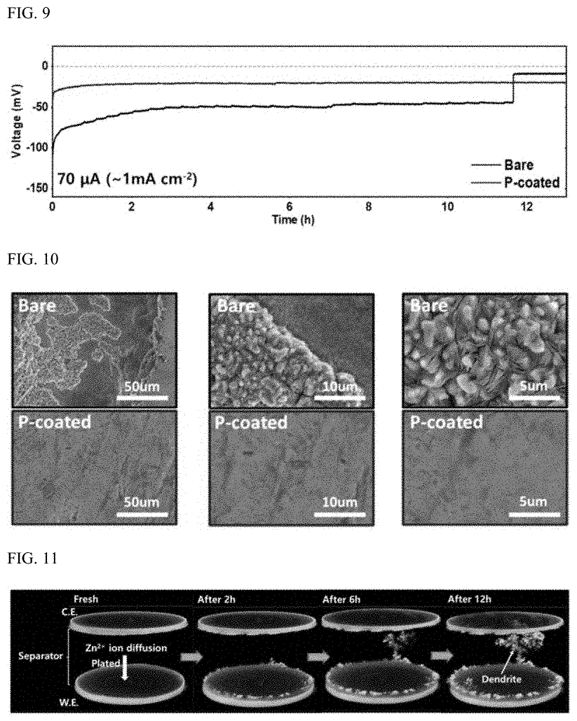

FIG. 9 is a synchrotron in situ imaging test result of a symmetric cell to which an anode having a protective layer formed thereon is applied according to a Manufacturing Example.

Referring to FIG. 9, in the manufacture of a cell for synchrotron in situ imaging, an anode including zinc metal and a protective layer formed thereon of Preparation Example was perforated to have holes with a diameter of 3 mm, and then used as an electrode of a symmetrical cell as in Manufacturing Example 1. The current applied to the cell for synchrotron in situ imaging was 400 ρA. In the case of using bare zinc metal as an anode (indicated as Bare in FIG. 9), it can be confirmed that the plating overvoltage of the initial charging cycle is −100 mV or more, and the short circuit of the cell occurs before the cycle reaches 12 hours. On the other hand, in the case of the symmetrical cell having the perforated anode including zinc metal and a protective layer formed thereon (indicated as P-coated in FIG. 9), it was confirmed that the plating overvoltage was smaller than that of the case where uncoated zinc metal was applied, and no short circuit occurred during a cycle test of 12 hours or more.

FIG. 10 shows SEM images of a surface of an anode after synchrotron in situ imaging test of a symmetric cell to which an anode having a protective layer formed thereon is applied according to Manufacturing Example.

Referring to FIG. 10, when zinc metal is used as an anode (indicated as Bare in FIG. 10), as a result of observing the surface of the zinc metal anode using SEM after a short circuit of the cell occurs, zinc dendrite seeds in an irregular shape are found on the surface of the anode. On the other hand, when the anode in which the zinc phosphate layer was formed according to Preparation Example 1 was used (indicated as P-coated in FIG. 10), it was confirmed that the surface of the anode exhibited a very uniform plating state even after the cycle test.

FIG. 11 is a synchrotron in situ 3D image of a zinc metal anode according to Comparation Example.

Referring to FIG. 11, when bare zinc metal is used as an electrode of a symmetrical cell, it can be seen that as the charge/discharge cycle progresses, plating is concentrated on the edge portion of the electrode and zinc dendrites are formed. As a result, after 12 hours, it was confirmed that the formed zinc dendrites penetrated the separator and reached the opposite electrode.

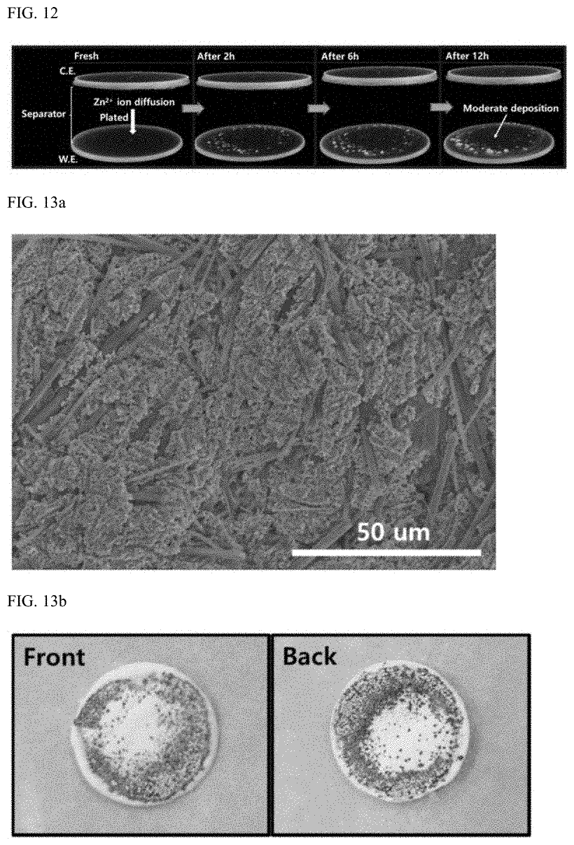

FIG. 12 is a synchrotron in situ 3D image of an anode for a zinc metal battery on which a protective layer is formed according to Manufacturing Example.

Referring to FIG. 12, when the anode with the protective layer formed thereon (Preparation Example) was used as an electrode of a symmetrical cell, it can be seen that zinc is evenly plated over the entire area of the electrode during the charge and discharge cycle, and even after the charge and discharge cycle was performed more than 12 hours, zinc plating proceeded evenly around the center of the electrode, and no formation of zinc dendrites penetrating the separator was observed. Accordingly, it can be seen that the short-circuit phenomenon of the battery due to the zinc dendrite does not occur in the symmetrical cell subjected to the cycle test.

FIG. 13a is a SEM image of a surface of an anode of a symmetrical cell according to Comparative Example after a cycle test under the conditions of a current density of 5 mA/cm² and a capacity of 1 mAh/cm² per cycle.

FIG. 13b is a digital camera image of a separator of a symmetrical cell according to Comparative Example after a cycle test under the conditions of a current density of 5 mA/cm² and a capacity of 1 mAh/cm² per cycle.

Referring to 13a and 13b, when zinc metal is used as an electrode of a symmetrical cell, irregular-shaped zinc dendrites and/or dead zinc, and fibers torn from the separator are observed on the surface of the anode, wherein the anode was obtained by separating the cell after the charge/discharge cycle test is completed. Furthermore, a large amount of dead zinc can be observed on the surface of the front and rear surfaces of the separator obtained from the cell after the charge/discharge test. Similar to the results shown in FIG. 11, it can be seen that zinc dendrites and/or dead zinc can penetrate the separator and cause a short circuit of the cell.

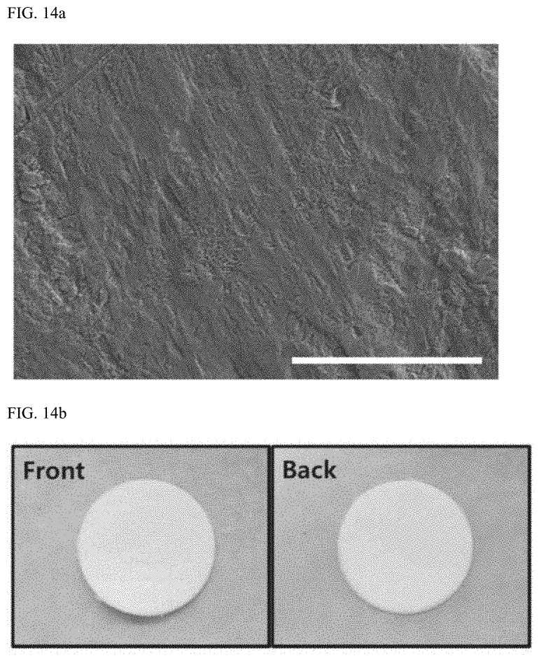

FIG. 14a is a SEM image of a surface of an anode including a protective layer of a symmetrical cell according to Manufacturing Example after a cycle test (condition: 5 mA/cm²//1 mAh/cm²).

FIG. 14b is a digital camera image of a separator of a symmetrical cell to which an anode having a protective layer formed thereon is applied according to Manufacturing Example after a cycle test (condition: 5 mA/cm²//1 mAh/cm²).

Referring to FIGS. 14a and 14b, the surface states of the separators and the anodes of the symmetric cells according to Comparative Example 1 and Manufacturing Example 1 are compared, after the charge/discharge cycle is completed. When the anode with the protective layer formed thereon was used as an electrode of a symmetrical cell, it can be seen that zinc is plated on the surface of the anode evenly and evenly overall, wherein the anode was obtained by separating the cell after the charge/discharge cycle test is completed. In particular, compared to the growth form of zinc dendrites in FIG. 13a, the anode surface state as above can enable relatively stable driving of the cell. In addition, unlike FIG. 13b, no zinc dendrites and/or dead zinc are found on the front and rear surfaces of the separator obtained by separating the cells after the charge/discharge test, and the original color and original shape of the separator are maintained. As in the result shown in FIG. 11, since the growth of zinc dendrites is uniform in a battery using the anode including the protective layer, the phenomenon of zinc dendrites penetrating the separator does not occur, preventing short circuit of the cell and improving stability of the cell.

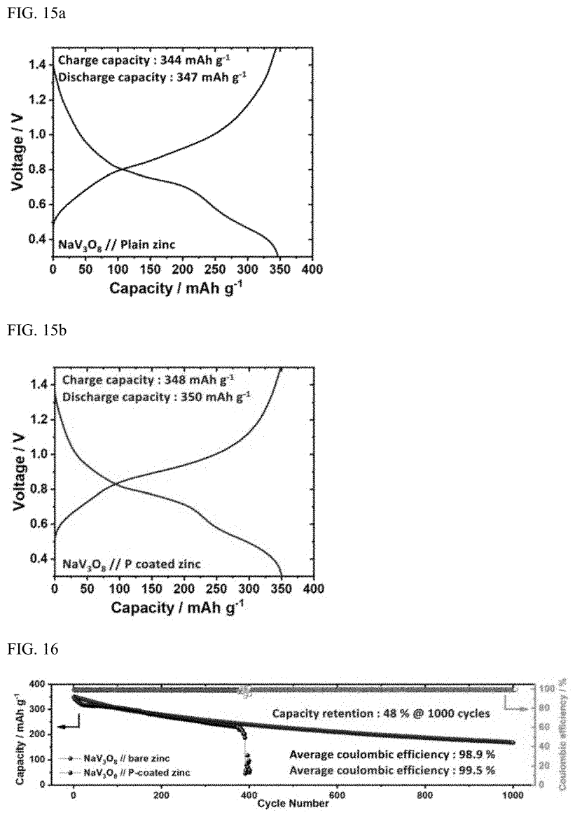

FIG. 15a is a first charge/discharge graph of a zinc metal battery to which a zinc metal anode is applied according to Comparative Example.

FIG. 15b is a first charge/discharge graph of a zinc metal battery to which an anode having a protective layer is applied according to Manufacturing Example.

Referring to FIGS. 15a and 15b, charge and discharge capacities of the zinc metal batteries according to Comparative Example 2 and Manufacturing Example 2 can be compared. When zinc metal was used as the anode (FIG. 15a, Comparative Example 2), the charge and discharge capacities were 344 mAh/g and 347 mAh/g, respectively. On the other hand, in the case of using an anode with a protective layer (FIG. 15b, Manufacturing Example 2), the charge and discharge capacities were 348 mAh/g and 350 mAh/g, respectively, which is better than the case where bare zinc metal was used as the anode.

FIG. 16 is a result of 1000 charge/discharge cycle test of a zinc metal battery to which an anode having a protective layer is applied according to Manufacturing Example and a zinc metal battery to which a zinc metal anode is applied according to Comparative Example.

Referring to FIG. 16, charge/discharge cycle characteristics of zinc metal batteries according to Comparative Example 2 and Manufacturing Example 2 are compared. In the case of using bare zinc metal as the anode (Comparative Example 2, marked as NaV₃O₈//bare zinc), the battery short circuit occurred after about 380 cycles, and the average coulombic efficiency was confirmed to be 98.9%. On the other hand, in the case of using the anode with a protective layer (Manufacturing Example 2, marked as NaV₃O₈//P-coated zinc) maintained a stable cycle even after 400 cycles, and the average coulombic efficiency was confirmed to be 99.5%. Therefore, it is confirmed that the zinc metal battery using the anode including the protective layer has better cycle stability and higher coulombic efficiency than the case of the battery using bare zinc metal as the anode.

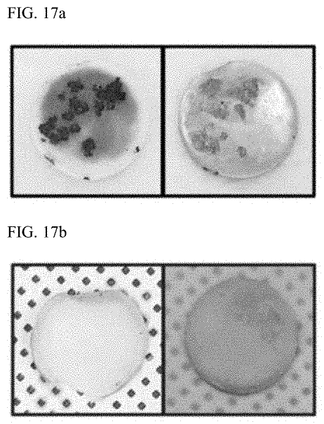

FIG. 17a shows digital camera images of a separator (left) and an anode (right) after 1000 charge/discharge cycle test of a zinc metal battery to which a zinc metal anode is applied according to Comparative Example.

FIG. 17b shows a digital camera images of a separator (left) and an anode (right) after 1000 charge/discharge cycle test of a zinc metal battery to which an anode having a protective layer is applied according to Manufacturing Example.

Referring to FIGS. 17a and 17b, after 1000 charge/discharge cycles of the zinc metal batteries according to Comparative Example 2 and Manufacturing Example 2 were completed, the batteries were separated and the surface states of separators and anodes were compared. Referring to FIG. 17a related to Comparative Example 2, a large amount of dead zinc was found on the surface of the separator, and it could be confirmed that the color of the separator changed to dark red due to deterioration. In addition, it can be seen that the surface of the anode is uneven and bumpy because zinc dendrites are irregularly formed on the surface of the anode. In contrast, in the case of FIG. 17b corresponding to Manufacturing Example 2, dead zinc attached to the surface of the separator was not found and a clean surface similar to the initial state was maintained, and it was observed that the anode also had a generally uniform and clean surface. Therefore, when the anode having the protective layer is applied to the zinc metal battery, generation of zinc dendrites or their irregular growth can be suppressed, and thus the cycle performance of the zinc metal battery can be improved.

The embodiments of the present invention disclosed in this specification and drawings are only presented as specific examples to aid understanding, and are not intended to limit the scope of the present invention. In addition to the embodiments disclosed herein, it is obvious to those skilled in the art that other modified examples based on the technical idea of the present invention can be implemented.

### DESCRIPTION OF REFERENCE NUMBER

10: anode, 11: zinc metal film, 13: protective layer, 20: cathode, 30: aqueous electrolyte

What is claimed is:

1. An anode for zinc metal battery comprising:
a zinc metal film containing zinc metal; and
a protective layer formed on the surface of the zinc metal film.

2. The anode for zinc metal battery according to claim 1, wherein PO⁻, HPO⁻, ZnPO⁻ and ZnHPO⁻ peaks are detected from the protective layer in ToF-SIMS analysis.

3. The anode for zinc metal battery according to claim 1, wherein the protective layer includes zinc phosphate.

4. The anode for zinc metal battery according to claim 1, wherein the protective layer has an orthorhombic structure as a crystal structure, and Pnma as a space group.

5. The anode for zinc metal battery according to claim 1, wherein the protective layer has a thickness of 5 to 15 nm.

6. A method for manufacturing an anode for a zinc metal battery comprising:
immersing a zinc metal film in a phosphoric acid aqueous solution; and
performing ultrasonic treatment to form a protective layer.

7. The method according to claim 6, wherein the protective layer includes zinc phosphate.

8. The method according to claim 6, wherein the protective layer has an orthorhombic structure as a crystal structure, and Pnma as a space group.

9. The method according to claim 6, wherein the ultrasonic treatment time is 1 to 30 minutes.

10. The method according to claim 6, wherein the protective layer has a thickness of 5 to 15 nm.

11. A zinc metal battery comprising:
an anode including a zinc metal film containing zinc metal and a protective layer formed on the surface of the zinc metal film;
a cathode containing a cathode active material; and
an aqueous electrolyte disposed between the anode and the cathode and containing a zinc salt.

12. The zinc metal battery according to claim 11, wherein the protective layer includes zinc phosphate.

13. The zinc metal battery according to claim 11, wherein the protective layer has an orthorhombic structure as a crystal structure, and Pnma as a space group.

14. The zinc metal battery according to claim 11, wherein the protective layer has a thickness of 5 to 15 nm.

15. The zinc metal battery according to claim 11, wherein the cathode active material includes alkali metal vanadium oxide or vanadium oxide.

16. The zinc metal battery according to claim 15, wherein the alkali metal vanadium oxide is MₓV₃O₈, M is an alkali metal, and x is 0.8 to 2.2.

17. The zinc metal battery according to claim 15, wherein the alkali metal vanadium oxide includes at least one selected from LiV₃O₈, NaV₃O₈ and K₂V₃O₈.

18. The zinc metal battery according to claim 15, wherein the vanadium oxide includes at least one selected from VO₂(B), V₂O₃ and V₂O₅.

19. The zinc metal battery according to claim 11, wherein the zinc salt includes at least one selected from ZnSO₄, Zn(NO₃)₂, Zn(CH₃CO₂)₂, Zn(CF₃SO₃)₂, ZnCl₂, and Zn(ClO₄)₂.

20. The zinc metal battery according to claim 11, wherein the aqueous electrolyte may have a pH of 3 to 7.
